(19) United States
(12) Patent Application Publication
(10) Pub. No.: US 2008/0304091 A1
(43) Pub. Date: Dec. 11, 2008

(54) IMAGE FORMING APPARATUS AND IMAGE FORMING METHOD

(75) Inventor: Kei Kobashigawa, Kanagawa-ken (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/122,183

(22) Filed: May 16, 2008

Related U.S. Application Data
(60) Provisional application No. 60/942,543, filed on Jun. 7, 2007.

(51) Int. Cl. G06F 15/00

(52) U.S. Cl. 358/1.13

(57) ABSTRACT

In an image forming apparatus, an image formation process is performed on image data in units of print jobs in a print mode of either one of a single-color print mode and a color print mode, the print mode is controlled to become the color print mode from the first page of the image data to a page of a designated page number, the print mode is controlled to become either one of the single-color print mode and the color print mode in a case where the designated page number is reached, and the designated page number is changed based on the number of the print jobs in a case where the image formation process reaches a designated number of times.

### BACKGROUND OF THE INVENTION

1. Field of the Invention

The present invention relates to an image forming apparatus such as a printer, a copier, a fax or a compound machine of these, and particularly to a tandem type image forming apparatus and an image forming method.

2. Description of the Related Art

A certain image forming apparatus (hereinafter referred to as a color image forming apparatus), such as a color printer or a color copier, includes an image transfer engine in which a total of four kinds of toners of Y (Yellow) toner, M (Magenta) toner, C (Cyan) toner and K (Black) toner used for printing of a character or the like, developing equipments for the respective toners, and drum-like photoreceptors are respectively integrated into units, and transfer is sequentially performed by respective transfer sections. In this color image forming apparatus, toner images are formed on the respective photoreceptors, the toner images are transferred to a print sheet via a transfer belt of an intermediate transfer body or are directly transferred to the print sheet, and there are included a color print mode in which the four kinds of toners are used to perform printing and a monochrome print mode in which one kind of only K is used to perform black and white printing.

As a print method at the time of the color print mode, there is a train-of-four tandem system in which a toner supply device, a development device and a photoreceptor corresponding to each of the four kinds of toners are integrated into a process unit, and the respective process units are provided on a sheet transport path, and after tone images of respective colors are formed on the respective photoreceptors, and the respective toner images are sequentially transferred onto one transfer sheet in one process, so that a high speed print process is realized.

In the process unit, there occurs degradation due to the friction between the photoreceptor and the intermediate transfer belt during printing, or there occurs wear between the rotating photoreceptor and the developing device. Then, in the color forming apparatus using the train-of-four tandem system, in general, at the time of the monochrome print mode, the process unit of K is brought into contact with the intermediate transfer belt, and the other process units of Y, M and C, which are not used, are separated from the intermediate transfer belt so that they do not operate, and unnecessary wear of the process units is prevented.

However, in a print job in which monochrome image data and color image data are mixed, in the case where the color image forming apparatus performs the switching operation of the print mode as stated above one by one, since the image forming operation of the color image forming apparatus is stopped or interrupted at each time of the switching operation, as the frequency of switching becomes high, it takes much time to complete the print job, and the productivity (throughput) of printing is degraded.

As stated above, in the color image forming apparatus of the train-of-four tandem system of the related art, when the throughput of printing is tried to be improved, the process unit is resultantly worn, whereas when switching of the print mode is performed by a mechanical method in order to reduce the wear of the process unit, the throughput is reduced.

Against this problem, a color image forming apparatus is proposed which has such a function that the default (predetermined or initial state adopted in the case where the user has not performed setting) of a print mode is made a monochrome mode, and although switching from a monochrome print mode to a color print mode can be performed in one print job execution, basically, when switching to the color mode is once performed, switching from the color print mode to the monochrome print mode is prohibited until the print job is completed, and in the case where a designated number of monochrome print pages is continuous, or in the case where a job of plural copies is designated in one print job, switching from the color print mode to the monochrome print mode can be performed at a gap between the respective copies (JP-A-2001-121788).

However, in the color image forming apparatus of the related art, since the default of the print mode is made the monochrome print mode, for example, in the case where the user mixes a color image in printing of a small number of sheets such as three sheets, switching to the color print mode is required, and it takes much time to print only a few sheets. Besides, printing can not be started until it is determined whether image data of the first sheet includes only monochrome print data, or the image data includes color print data, and print start speed becomes low. Besides, for example, in the case where plural copies of image data including two pages in which the first page is monochrome and the second page is color are printed, the monochrome image data and the color image data are alternately printed, and switching to the monochrome print mode of the default is performed at a gap between the copies, and accordingly, the switching of the print mode occurs one by one, and the throughput of the printing becomes very poor.

### SUMMARY OF THE INVENTION

An embodiment of the invention has an object to provide an image forming apparatus and an image forming method in which even in a print job in which data of a single color image, such as a monochrome image, and a color image are alternately printed, switching between a single-color print mode and a color print mode is controlled based on a designated parameter, so that while the throughput of the print job is ensured so as to make full use of high speedness as a merit of a train-of-four tandem system, the wear of a process unit can be suppressed.

Besides, an embodiment of the invention has an object to provide an image forming apparatus and an image forming method in which a correction is made so that the foregoing parameter becomes an optimum value according to the use state of a user.

In order to solve the problem, according to an aspect of the invention, an image forming apparatus includes an image formation process unit configured to perform an image formation process on image data in units of print jobs in a print mode of either one of a single-color print mode and a color print mode, a print mode control unit configured to control the print mode to become the color print mode from the first page of the image data to a page of a designated page number, and to control the print mode to become either one of the single-color print mode and the color print mode in a case where the designated page number is reached, and a change unit configured to change the designated page number based on the number of the print jobs.

Besides, in order to solve the problem, according to another aspect of the invention, an image forming apparatus includes an image formation process unit configured to perform an image formation process on image data in units of print jobs in a print mode of either one of a single-color print mode and a color print mode, a print mode control unit configured to control the print mode to become the color print mode until a designated time has passed since an image formation start of the image formation process unit on the image data, and to control the print mode to become either one of the single-color print mode and the color print mode in a case where the designated time has passed, and a change unit configured to change the designated time based on the number of the print jobs.

Besides, in order to solve the problem, according to another aspect of the invention, an image forming method includes performing an image formation process on image data in units of print jobs in a print mode of either one of a single-color print mode and a color print mode, controlling the print mode to become the color print mode from the first page of the image data to a page of a designated page number, controlling the print mode to become either one of the single-color print mode and the color print mode in a case where the designated page number is reached, and changing the designated page number based on the number of the print jobs in a case where the image formation process reaches a designated number of times.

### DESCRIPTION OF THE DRAWINGS

FIG. 1 is a whole structural view showing a color image forming apparatus of an embodiment.

FIG. 2 is a whole structural view showing a form in a case where the separation of an intermediate transfer belt is performed in the color image forming apparatus of the embodiment.

FIG. 3 is a control block diagram of the color image forming apparatus of a first embodiment.

FIG. 4 is a flowchart showing a switching operation of the color image forming apparatus of the first embodiment.

FIG. 5 is a control block diagram of a color image forming apparatus of a third embodiment.

FIG. 6 is a flowchart showing a switching operation of the color image forming apparatus of the third embodiment.

FIG. 7 is a flowchart showing a correction process (subtraction process) of X1 in the color image forming apparatus of the third embodiment.

FIG. 8 is a flowchart showing a correction process (addition and subtraction process) of X1 in the color image forming apparatus of the third embodiment.

FIG. 9 is a flowchart showing a correction process (process taking the upper and lower limit values into consideration) of X1 in the color image forming apparatus of the third embodiment.

### DESCRIPTION OF THE EMBODIMENTS

Hereinafter, embodiments of the invention will be described with reference to the drawings.

### First Embodiment

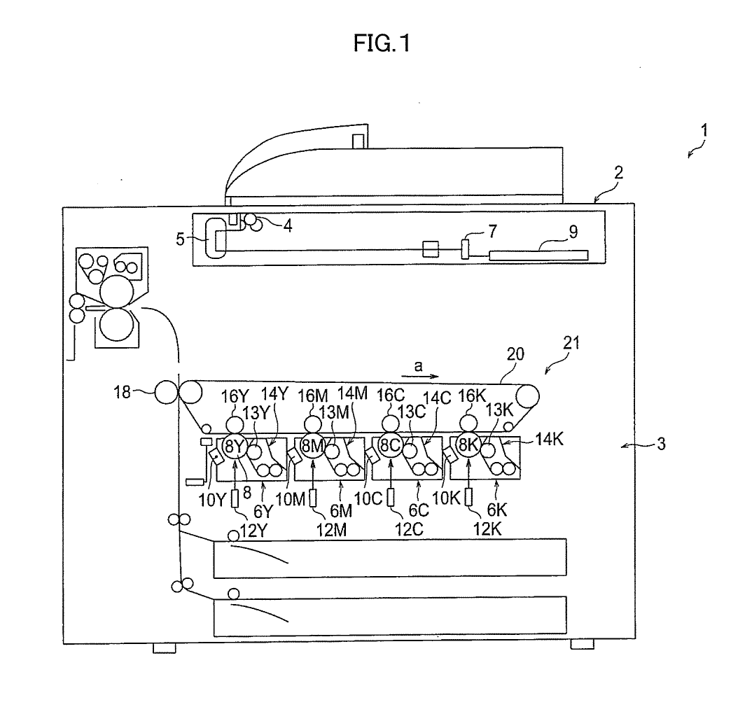

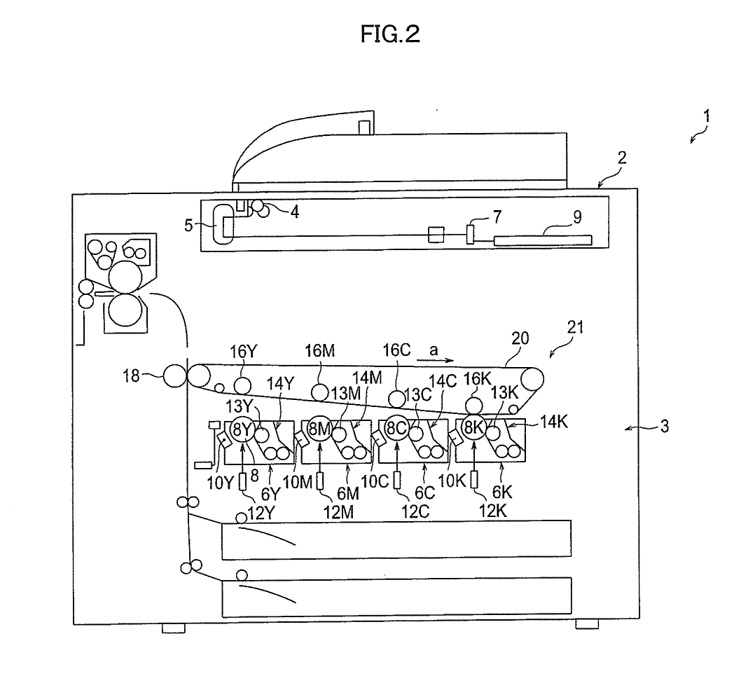

FIG. 1 and FIG. 2 are whole structural views showing a color image forming apparatus of an embodiment of the invention, FIG. 1 shows a form in a color print mode, and FIG. 2 shows a form in a monochrome print mode. Hereinafter, the color print mode of the embodiment is a print mode in which for example, process units of Y (Yellow), M (magenta), C (Cyan) and K (Black) are in contact with an intermediate transfer belt, and image formation is performed. The monochrome print mode is a single-color print mode in which a process unit of a single color is brought into contact with an intermediate transfer belt, and the other plural process units, which are not used, are separated from the intermediate transfer belt so that they do not operate, and is a print mode in which a process unit of K is brought into contact with the intermediate transfer belt, and the other process units of Y, M and C, which are not used, are separated from the intermediate transfer belt so that they do not operate.

A color image forming apparatus 1 (image forming apparatus) includes a scanner unit 2 as a read function and a printer unit 3 as an image forming function.

The scanner unit 2 includes an exposure lamp 4 to irradiate light to an original document, a reflection mirror 5 to guide the reflected light from the original document, a CCD 7 (Charge Coupled Device) to capture the reflected light and to convert image information of the light into an analog signal, and a scanner main control unit 9 to control the scanner unit 2. The image data captured by the CCD 7 is sent to an after-mentioned system main control unit 22 in the printer unit 3 via the scanner main control unit 9.

The printer unit 3 includes therein an intermediate transfer belt 20 as a transfer body, and four process units 6Y, 6M, 6C and 6K corresponding to the respective colors of yellow (Y), Magenta (M), Cyan (C) and Black (K).

The process units 6Y, 6M, 6C and 6K include photoconductive drums 8Y, 8M, 8C and 8K as image carriers, charging devices 10Y, 10M, 10C and 10K to charge the photoconductive drums 8Y, 8M, 8C and 8K, laser units 12Y, 12M, 12C and 12K to form electrostatic latent images on surfaces of the charged photoconductive drums 8Y, 8M, 8C and 8K on the basis of image data sent to the system main control unit 22, development units 14Y, 14M, 14C and 14K having development rollers 13Y, 13M, 13C and 13K for attaching toners to the photoconductive drums 8Y, 8M, 8C and 8K, and primary transfer rollers 16Y, 16M, 16C and 16K as transfer means opposite to the photoconductive drums 8Y, 8M, 8C and 8K across the intermediate transfer belt 20, and are arranged side by side along the intermediate transfer belt 20. Toner images transferred to the intermediate transfer belt 20 by the primary transfer rollers 16Y, 16M, 16C and 16K are transferred onto the print sheet transported by a secondary transfer roller 18, and are fixed onto the print sheet by subsequent fixation.

By single color (monochrome)/color switching means 21, here, by the moving primary transfer rollers 16Y, 16M, 16C and 16K, the printer unit 3 can switch between a state in which the intermediate transfer belt 20 is in press contact with the photoconductive drums 8Y, 8M, 8C and 8K as shown in FIG. 1, and a state in which only the photoconductive drum 8K is in press contact with the intermediate transfer belt 20, and the other unused photoconductive drums 8Y, 8M and 8C are separated from the intermediate transfer belt 20 as shown in FIG. 2. Accordingly, in general, in the color print mode, printing is performed in the state of FIG. 1, and in the single color (monochrome) print mode, printing is performed in the state of FIG. 2.

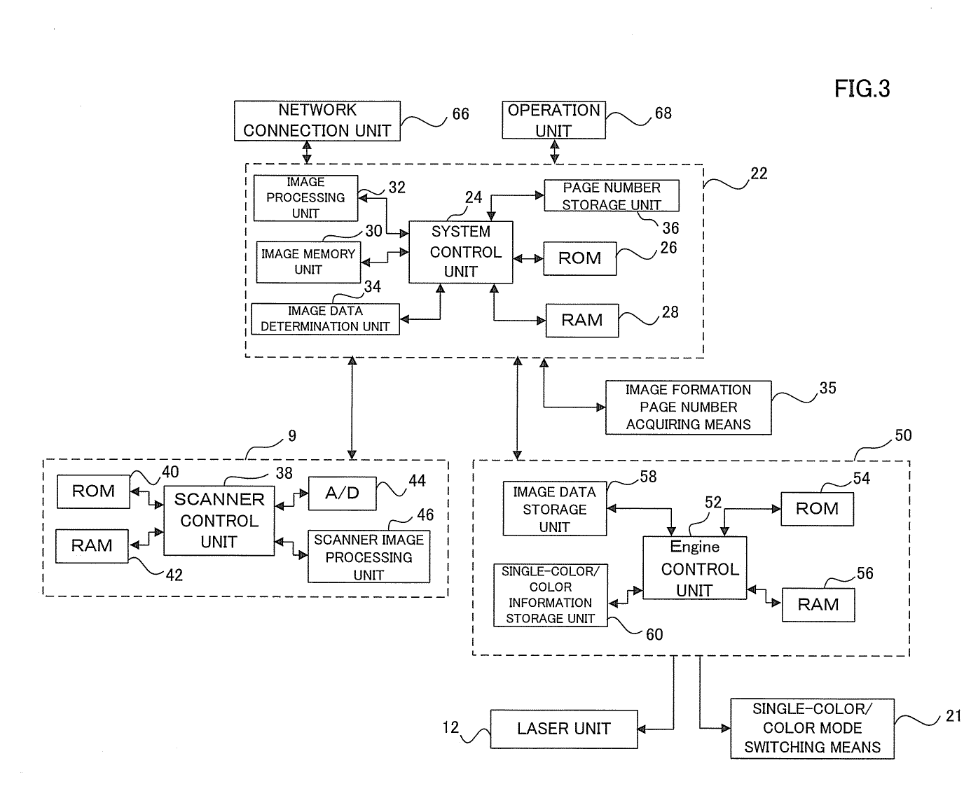

FIG. 3 is a block diagram of a control system to control the operation of the color image forming apparatus 1.

The color image forming apparatus 1 of the first embodiment includes a system main control unit 22, a printer main control unit 50, and a scanner main control unit 9.

The system main control unit 22 is disposed in the printer unit 3, has a function as the center of the whole system in the color image forming apparatus 1, communicates with a scanner control unit 38 of the scanner main control unit 9 and an engine control unit 52 of the printer main control unit 50 based on information inputted from an after-mentioned operation unit 68 or a PC connected through a network connection unit 66, and issues operation instructions to the scanner main control unit 9 and the printer main control unit 50.

The system main control unit 22 includes a system control unit (for example, CPU) 24 to control the whole system main control unit 22, a ROM (storage unit) 26 to store a control program of the system control unit 24 and various data, a RAM 28 as a work area of the system control unit 24, an image memory unit 30 for storing various data such as image data having color space information sent from an external terminal, such as a PC or a server, connected through the network connection unit 66, image data captured by the scanner unit 2, or image data generated based on those image data, an image processing unit 32 to perform various image processes on the captured image data and to convert it into, for example, YMCK image data, an image data determination unit 34 to determine whether the image data having the color space information is monochrome image data or color image data, and image formation page number acquiring means 35 for acquiring the number of pages of the printed image data.

Further, the system main control unit 22 includes a page number storage unit 36 having a first page number storage unit 36a to store a page number Q (the number of sheets) of image data printed since the start of one print job, which is acquired by the image formation page number acquiring means 35, a second page number storage unit 36b to store the total page number R (the number of sheets) of image data in one print job, a third and a fourth page number storage units 36c and 36d to respectively store a first operation switching determination sheet count X1 (designated page number) which can be previously set and a second operation switching determination sheet count X2, and a fifth page number storage unit 36e to store a (remaining) page number S of remaining image data in one print job. Here, rewritable nonvolatile memories are used for the third and the fourth page number storage units 36c and 36d, and rewritable nonvolatile memories or volatile memories, or buffers are used for the first, the second, and the fifth page number storage units 36a, 36b, and 36e.

In the data stored in the page number storage unit 36, the first and the second operation switching determination sheet counts X1 and X2 are previously set by a maker, or can be set and changed by the user from the PC or the operation unit 68 according to the use state. The system main control unit 22 uses the data Q, R, X1 and X2 stored in the page number storage unit 36, and the image data determination unit 34 to determine (set) whether the print mode is made the single-color print mode or the color print mode, and sends the determination result to the printer main control unit 50, and further outputs YMCK image data from the image processing unit 32 to the printer main control unit 50 (the details will be described later).

The scanner main control unit 9 is a portion to mainly control the scan function, and includes the scanner control unit 38 to control the whole scanner main control unit 9, a ROM 40 to store a control program of the scanner control unit 38 and various data, a RAM 42 as a work area of the scanner control unit 38, an A/D converter 44 to convert an analog signal outputted from a CCD into a digital signal, and a scanner image processing unit 46 to process image data of an original document read by scanning. The image data processed here is sent to the system main control unit 22, and then is outputted to the printer main control unit 50.

The printer main control unit 50 is a portion to mainly control the print function of the printer unit 3, and includes the engine control unit 52 to control the whole printer main control unit 50, a ROM 54 to store a control program of the engine control unit 52 and various data, a RAM 56 as a work area of the engine control unit 52, an image data storage unit 58 to store YMCK image data sent from the system main control unit 22, and a single-color/color information storage unit 60 to store the determination result sent from the system main control unit 22 and indicating whether the YMCK image data stored in the image data storage unit 58 is printed in the single-color print mode or the color print mode, and the present print mode.

The printer main control unit 50, together with the system main control unit 22, constitutes the control unit of the printer unit 3, and the engine control unit 52 issues operation instructions to the laser unit and the single-color/color mode switching means 21 for performing switching between the single-color print mode and the color print mode. The single-color/color mode switching means 21 performs press contact and separation between the intermediate transfer belt 20 and the process unit, that is, moves the intermediate transfer belt 20 relative to the process unit to perform the press contact and separation between the intermediate transfer belt 20 and the photoconductive drum.

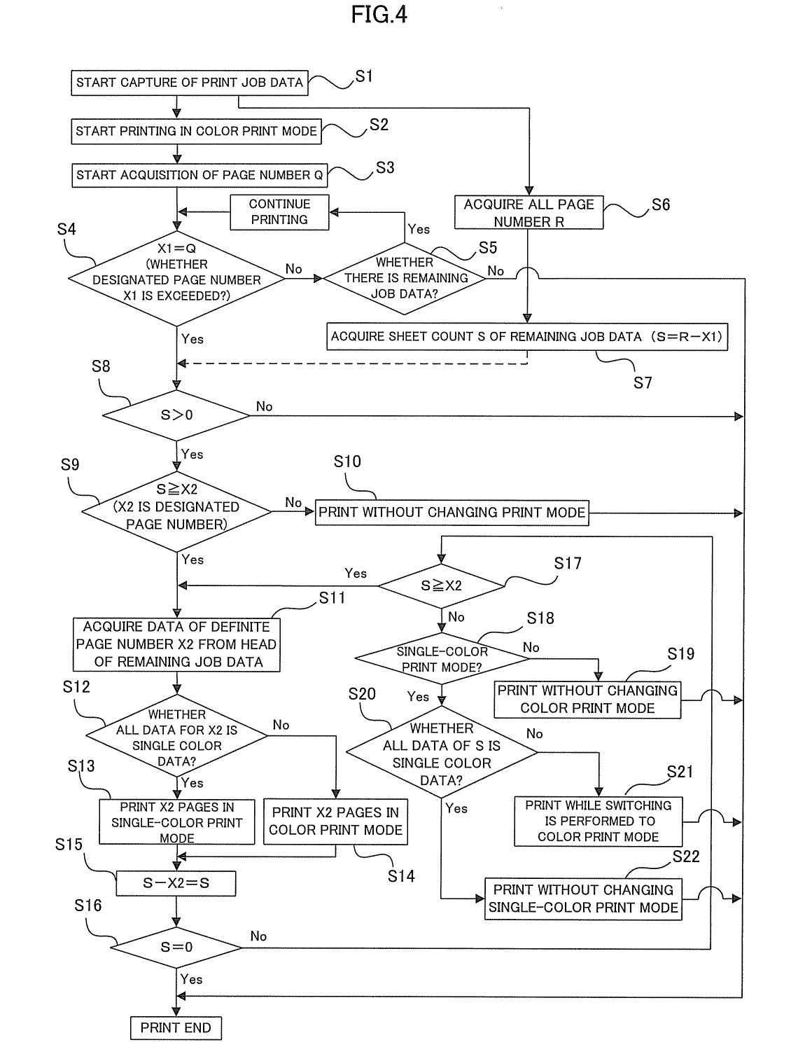

Next, the print operation of the color image forming apparatus of the first embodiment will be described by use of FIG. 4. FIG. 4 is a flowchart showing the print operation of the color image forming apparatus of the first embodiment.

In general, the user operates the operation panel (operation unit) 68 and can select a full color, a single color (for example, monochrome), or an auto (automatic) print mode from the print property of the printer driver of the PC. In the case where the full color and the single-color print mode are selected, in one print job, printing of all image data is completed in the selected print mode, that is, in the color print mode when the full color is selected, and in the single-color print mode when the single color is selected. On the other hand, when the auto color print mode is selected, in one print job, image data is printed while switching between the single-color print mode and the color print mode is performed based on the image data. Accordingly, here, the print operation in the case where printing is started in the auto color print mode will be described. In the following, the “single-color print mode” is a monochrome print mode in which K toner is used as single-color toner in the single-color print mode, the process unit 6K of K is brought into contact with the intermediate transfer belt 20, and the other process units 6Y, 6M and 6C of Y, M and C, which are not used, are separated from the intermediate transfer belt 20 and the like so that they do not operate.

Incidentally, the initial state (default) of the print mode is made the color print mode in which the photoconductive drums 8Y, 8M, 8C and 8K are in press contact with the intermediate transfer belt 20.

First, when a request for image formation is issued from the PC or the like, a print job start instruction is transmitted to the system main control unit 22 through the network connection unit 66, the capture of image data (one image data for one print job) in units of print jobs is started by the system main control unit 22 (step S1), and in all image data of the one print job, image data from the first of the print job to the page X1 (in the case where the total page number of the whole image data of the one print job is smaller than the previously set first operation switching determination sheet count X1, the image data of all pages) is converted into YMCK image data by the image processing unit 32, and then is immediately outputted to the printer main control unit 50 without being sent to the image data determination unit 34, and image formation is started in the printer unit 3 (step S2). At this time, the print mode is the color print mode of the default, and since the photoconductive drums 8Y, 8M, 8C and 8K are already in contact with the intermediate transfer belt 20, an image is quickly formed from the YMCK image data outputted to the printer main control unit 50.

When the image formation is started, the image formation page number acquiring means 35 detects, for example, the completion of image formation to the intermediate transfer belt or passing of a sheet through the fixing unit by a sensor or the like, or detects and counts a sheet on which image formation is completed from the size of the print sheet, the number of rotations of the transport roller, the feed interval of the sheet and the like, the acquisition of the page number Q (the number of sheets) of the image data printed from the start of one print job is started, and the page number Q is stored in the first page number storage unit 36a of the page number storage unit 36 (step S3).

Next, steps 4 and steps 5 are repeated until the page number Q reaches the first operation switching determination sheet count X1. That is, for example, each time the image formation to the intermediate transfer belt 20 is completed, the page number Q stored in the page number storage unit 36a is compared with the designated page number X1 stored in the third page number storage unit 36c by the system control unit 24, and it is determined whether the page number Q reaches the designated page number X1 (step S4). Here, as described in step S4, the system control unit 24 serves also as a control unit to compare information stored in the page number storage unit 36.

As a result of step S4, in the case where the page number Q in which the image formation is already completed is smaller than the designated page number X1, advance is made to step S5, and in the case where there is remaining job data, the image formation is continued, and in the case where there is no remaining job data, the image formation is completed.

On the other hand, when the capture of print job data is started at step S1 and the image data of one print job is completely transmitted from the PC or the like to the system main control unit 22, the total page number R of the image data in the one print job is stored in the second page number storage unit 36b of the page number storage unit 36 (step S6). At step S6, when the total page number R is acquired, the system control unit 24 uses the total page number R in the page number storage unit 36, and the designated page number X1 to acquire the remaining job data number S (S=R−X1) as the remaining page number of the print job, and the remaining job data number S is stored in the fifth page number storage unit 36e of the page number storage unit 36 (step S7). As stated above, step S6 and step S7 are performed in parallel to the image formation, and the image formation in the color print mode is immediately started as in step S2, so that the throughput of the print job at the time of image formation start is improved.

Next, a case where the total page number R of one print job data is the designated page number X1 or more will be described. In this embodiment, various determinations subsequent to step S8 are previously performed by the system control unit 24 while steps S4 and S5 are being performed, and after that, the image formation is performed in accordance with the determination results. Accordingly, at step S4, in the case where the page number Q in which printing is completed and which is acquired by the image formation page number acquiring means 35 reaches the designated page number X1, a shift can be immediately made to a next operation such as image formation or operation mode switching. However, in the case where they are not finished while step S4 and S5 are being performed, the remaining various determinations are continued in parallel to the image formation.

At step S8, in the case where there is no acquired remaining job data (S≦0), the image formation is ended, and in the case where there is remaining job data number S (S>0), advance is made to step S9, and the system control unit 24 makes a comparison between the previously set second operation switching determination sheet count X2 stored in the fourth page number storage unit 36d of the page number storage unit 36 and the remaining job data number S.

In the case where the remaining job data number S is smaller than the designated page number X2, irrespectively of whether the remaining image data is monochrome or color, the print mode is not changed, and the image formation of the remaining image data is continued and ended (step S10).

On the other hand, in the case where the remaining job data number S is the designated page number X2 or more, the image data is captured into the image data determination unit 34 of the system main control unit 22 in units of X2 pages from the first of the remaining job data (step S11), and it is determined whether all image data are monochrome data or include a color image (step S12). The determination result of the image data determination unit 34, together with the YMCK image data in units of X2 pages stored in the image memory unit 32, is outputted to the printer main control unit 50. The determination result of whether all image data in units of X2 pages outputted from the system main control unit 22 are monochrome image or include the color image is stored in the single-color/color information storage unit 60, and the YMCK image data in units of X2 pages is stored in the image data storage unit 58. Incidentally, the image data storage unit 58 is not necessarily required to be provided in the printer main control unit 50, but may be provided on the system main control unit 22, or the YMCK image data may be directly read from the image memory unit.

Next, based on the determination result of the image data in units of X2 pages stored in the single-color/color information storage unit 60, the engine control unit 52 controls the single-color/color mode switching means 21, and the print mode is switched. In the case where all the image data in units of X2 pages are single color data, image formation of the image data in units of X2 pages is performed in the single-color print mode (step S13), and in the case where the image data in units of X2 pages include a color image, image formation of the image data in units of X2 pages is performed in the color print mode (step S14). In the page number storage unit 36, the designated page number X2 is subtracted from the previous remaining job data number S, and the remaining job data number S is updated (step S15), and at step S16, in the case where there is no remaining job data (S=0), the image formation is completed. Here, the update of the remaining job data number S may be performed in units of X2 pages or may be performed each time counting is performed by the image formation page number acquiring means 35.

On the other hand, in the case where there is remaining job data number S at step S16, similarly to step S9, the system control unit 24 makes a comparison between the designated page number X2 stored in the fourth page number storage unit 36d of the page number storage unit 36 and the updated remaining job data S (step S17). In the case where the remaining job data number S is the designated page number X2 or more (S2×2), advance is made to step S11, and the above operation is repeated, and in the case where the remaining job data number S is smaller than the designated page number X2 (S<X2), the process proceeds to step S18. The print mode remains the color print mode of the default according to the determination at step S12, or is switched to the single-color print mode, and accordingly, at step S18, the present print mode of the single-color/color mode switching means 21 is determined by the engine control unit 52.

At step S18, in the case where the print mode of the single-color/color mode switching means 21 is the color print mode, even if all the remaining job data are the single color data, the print mode is not changed, leaving the color print mode unchanged, and the image formation of the remaining data is performed, and the print job is completed (step S19). On the other hand, in the case where the print mode is the single-color print mode, the image data determination unit 34 determines whether all the remaining job data is single color data or includes a color image (step S20), and the determination result, together with the YMCK image data in units of X2 pages stored in the image memory unit 32, is outputted to the printer main control unit 50. The determination result of the image data in units of X2 pages is stored in the single-color/color information storage unit 60, and the YMCK image data in units of X2 pages is stored in the image data storage unit 58. Based on the determination result stored in the single-color/color information storage unit 60, in the case where the image data in units of X2 pages includes a color image, the engine control unit 52 controls the single-color/color mode switching means 21 to perform switching to the color print mode, image formation of the remaining data is performed (step S21), and the print job is completed. On the other hand, in the case where all are single color data, the image formation is continued without changing the print mode, and the print job is completed (step S22).

Besides, the setting and change of the designated page numbers X1 and X2 can also be performed during the image formation. In this case, the designated page number X1 of the new set value is reflected on the next image formation of a print job. On the other hand, the designated page number X2 of a new set value is immediately reflected on the image formation subsequent to step S9 when the step of the image formation is before step S9, is reflected at the time point of step S17 when it is changed between step S9 and step S15, and is reflected on the next image formation of a print job in the case where it is changed after step S18.

Besides, in the above, although the switching determination of the print mode after the designated page number X1 is performed before the print page number reaches the designated page number X1 at step S4, no limitation is made to this, and according to the performance of the color image forming apparatus, switching determination may be performed for each image data in units of X2 pages at the time point when the image formation in units of X1 pages, X2 pages is ended at step S4, step S16, or switching determination may be performed for each image data in units of X2 pages while the image formation is being performed.

As described above, in the auto color mode, the default of the print mode of the color image forming apparatus is made the color print mode, the designated page number X1 which can be set and changed is previously decided, and in the case where the image formation request is generated, the image formation is immediately started, and until the print page number reaches the first designated page number X1, the determination as to whether the image data is single color data or color data is not performed, and the switching operation of the print mode is not performed, and therefore, the throughput of the print job at the time of image formation start is improved. Accordingly, according to the color image forming apparatus 1, unlike a case where image formation is started after all image data amount of the print job is grasped, it is prevented that a state occurs where the time for grasping the data is wasted and printing is not started, and the reduction of the throughput at the time of image formation start can be avoided. Further, differently from the color image forming apparatus of the related art, in the case where the requested image formation sheet count is the first designated page number X1 or smaller, the color image forming apparatus 1 does not perform the switching operation of the print mode, and therefore, the throughput of image formation is good.

Besides, in the case where the requested image formation sheet count is the first designated page number X1 or more, the second designated page number X2 which can be previously set and changed is made the standard for determination, and the switching of the print mode is performed, and accordingly, even in the case where the print job in which single-color image data and color image data are alternately requested is printed while the user is unconscious of it, the color image forming apparatus 1 ensures the throughput of the print job so as to make the best use of the high speedness as the merit of the train-of-four tandem system, and the wasteful wear of the process unit can be suppressed.

Further, the switching determination of the print mode after the first designated page number X1 can also be performed before the print page number reaches the designated page number X1. By performing the parallel process as stated above, according to the color image forming apparatus 1, unlike a case where image formation is started after image formation reaches the first designated page number X1 and after the remaining image data amount of the print job is grasped, it is prevented that a state occurs where a time for grasping the data is wasted and printing can not be started, and the reduction of the throughput at the time of image formation start can be avoided.

Incidentally, in a general full color print mode, printing of a black image is performed by superimposing plural colors of Y, M, C and K, however, in the “color print mode” of the first embodiment, although the photoconductive drums Y, M, C and K are in press contact with the intermediate transfer belt, printing may be actually performed using only the K toner.

Besides, in the first embodiment, although the single-color/color mode switching means 21 performs the press contact and separation between the intermediate transfer belt 20 and the photoconductive drums 8Y, 8M, 8C and 8K by moving the intermediate transfer belt 20 relative to the photoconductive drum, no limitation is made to this structure, and the press contact and separation between the intermediate transfer belt 20 and the photoconductive drums 8Y, 8M, 8C and 8K may be performed by moving the photoconductive drums 8Y, 8M, 8C and 8K. In this case, since the single-color (monochrome)/color mode switching means 21 can bring only one of the photoconductive drums 8Y, 8M, 8C and 8K into press contact with the intermediate transfer belt 20, as the print mode, not only the monochrome printing, but also, for example, a single-color print mode of Y becomes possible, and the single-color (Y or M or C or K)/color print mode becomes possible.

Besides, in the color image forming apparatus 1 of the first embodiment, as the determination standard for the switching operation of the print mode, the designated page numbers X1 and X2 or the page number Q acquired by the image formation page number acquiring means 35 is managed by page number, however, a timer or the like is used in the image formation page number acquiring means 35, and a time required for the image formation of printed pages or remaining pages is obtained and the management may be performed. The details will be described in a second embodiment.

Besides, in the color image forming apparatus 1 of the first embodiment, the image data determination unit 34 determines whether the image data on which image formation is instructed is monochrome image data or color image data, however, for example, when image data on which image formation is instructed is transmitted from a PC, in the case where the determination as to whether the image data is monochrome image data or color image data is performed on the PC, and the information of the determination result, together with the image data, is transmitted to the color image forming apparatus, the image data determination unit 34 provided in the color image forming apparatus may not perform the determination of the image data.

Besides, in the color image forming apparatus 1 of the first embodiment, although the toner image transferred on the intermediate transfer belt 20 is transferred onto the transported print sheet by the secondary transfer roller 18, no limitation is made to this, and a structure may be made such that the intermediate transfer belt 20 is not provided, but the sheet is transported by the transfer belt, and the toner image formed on the photoconductive drum 8 is transferred to the sheet during the process.

### Second Embodiment

In the color image forming apparatus of the first embodiment, the determination standard for the switching operation of the print mode is the number of pages, such as the designated page numbers X1 and X2 or the page number Q acquired by the image formation page number acquiring means 35, however, in a color image forming apparatus of a second embodiment, a timer or the like is provided in image formation page number acquiring means 35, and the time is made a determination standard for a switching operation of a print mode.

The process content of the color image forming apparatus 1 of the second embodiment can be considered similarly to the process flow (see FIG. 4) of the first embodiment. That is, the page number Q (the number of sheets) of the printed image data in FIG. 4 is made an elapsed time PT (hereinafter referred to as PT time) from the start of one print job, and the first designated page number X1 is made a designated time T1 (hereinafter referred to as T1 time) (designated time) from the drive start (image formation start) of a photoconductive drum 8K (photoconductive drum in contact with the intermediate transfer belt 20 in both modes of the single-color print mode and the color print mode). Besides, the second designated page number X2 is made a designated time T2 (hereinafter referred to as T2 time). Incidentally, the reason why the drive time of the photoconductive drum 8K is made the standard of the T1 time is that the photoconductive drum 8K is always driven in both the modes.

In the process of the second embodiment, at step S3 of FIG. 4, acquisition of the PT time is started, and at step S4, Yes occurs in the case where the PT time becomes the T1 time or more (conversely, No occurs in the case where the PT time is less than the T1 time).

Besides, in the process of the second embodiment, in the process of step S7 of FIG. 4, a remaining job data number S (S=R−X1, R and X1 are the same as those of the first embodiment) is acquired, and a remaining estimated time T is also acquired.

The remaining estimated time T is calculated based on the remaining job data number S for which image formation has not been performed and the sheet size (for example, A3 size, A4 size, etc. as standard sizes of Japan) of image data for which image formation has not been performed. That is, required times per unit number of sheets for color images and monochrome images, such as, for example, a time per unit number of sheets required for image formation of a color image of A3 size and a time per unit number of sheets required for image formation of a monochrome image of A4 size, are previously defined and set for the respective sheet sizes, and the remaining estimated time T is obtained based on these set values and the remaining job data number S. Further, when the kind of the sheet (for example, standard paper, OHP sheet), and the print mode switching time of the single-color/color mode switching means 21 are also considered, a more accurate remaining estimated time can be obtained.

Besides, in the process of the second embodiment, at step S9 of FIG. 4, a comparison is made between the remaining estimated time T and the T2 time, and Yes occurs in the case where the remaining estimated time T is the T2 time or more, and No occurs in the case where the remaining estimated time T is smaller than the T2 time.

Further, in the process of the second embodiment, in the process of step S11 of FIG. 4, X2 is made a page number which can be processed in the T2 time (X2 in the second embodiment is different from that of the first embodiment, and X2 in the second embodiment is calculated based on the required time per unit number of sheets of the color image or monochrome image for each size and the T2 time), and data for X2 is acquired from the head of the remaining job data number S.

The process of the second embodiment can be considered similarly to the process of the first embodiment by replacing the respective parameters and steps.

Incidentally, in the color image forming apparatus 1 of this embodiment, in the case where the control time (T1 time or T2 time) is reached in the middle of image formation to the sheet, the print mode is controlled immediately when the image formation of the sheet presently processed is completed.

Besides, the T1 time and the T2 time can be set by a maker or by a user according to the use state similarly to the designated page numbers X1 and X2 in the first embodiment.

The management is made by the time as in the second embodiment, so that a sheet size, which can not be managed by the page number as in the first embodiment, can also be taken into consideration.

Incidentally, in the color image forming apparatus 1 in the second embodiment, although the timer is provided in the image formation page number acquiring means 35, the timer may be disposed at any place as long as data communication with the system main control unit 22 can be performed.

### Third Embodiment

Although the first operation switching determination sheet count X1 of the first embodiment is previously set by the maker or is set and changed by the user from the PC (or the operation unit 68) according to the use state, in a third embodiment, it is automatically updated according to the use state of the user.

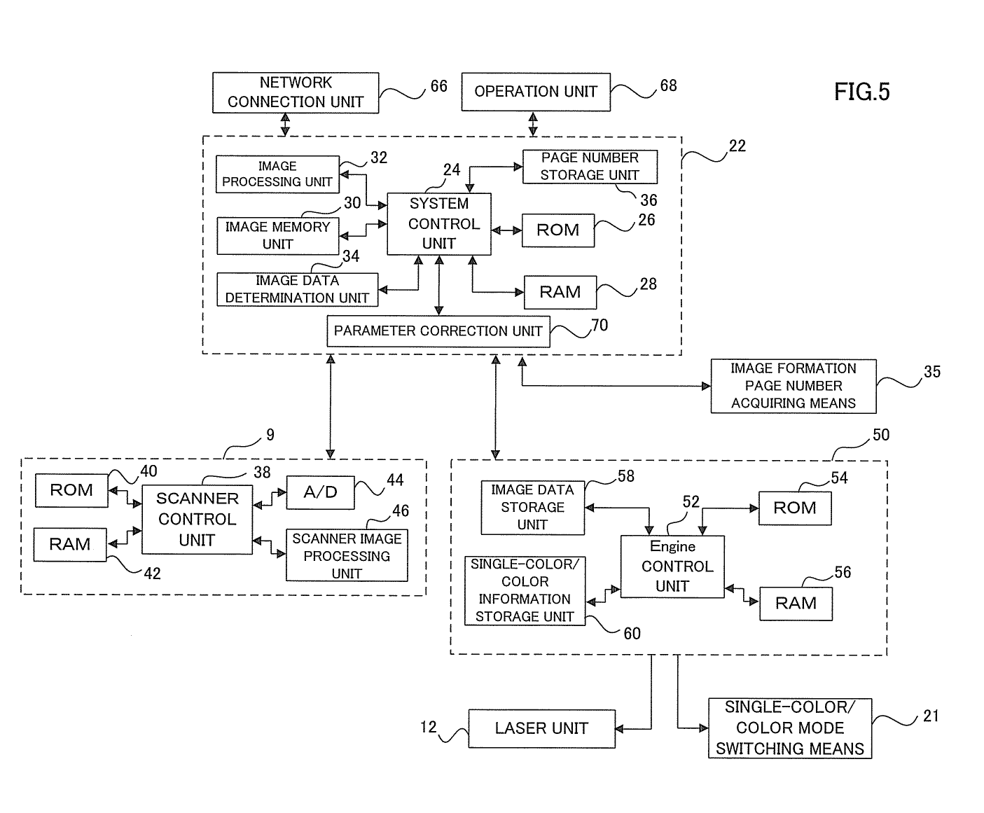

FIG. 5 is a block diagram of a control system to control the operation of a color image forming apparatus of the third embodiment. As compared with the first embodiment, the color image forming apparatus 1 of the third embodiment further includes a parameter correction unit 70 to correct the operation switching determination sheet count X1 in a system main control unit 22. Besides, a page number storage unit 36 of the color image forming apparatus 1 of the third embodiment includes a sixth page number storage unit 36f to store the number c of times of reception of a print job (the number of print jobs in which image formation process is performed) and the number X of print jobs exceeding the operation switching determination sheet count X1 (the number of print jobs in which the number of pages of the image data reaches the designated page number). Those other than the parameter correction unit 70 and the sixth page number storage unit 36f are similar to the first embodiment, their description will be omitted here.

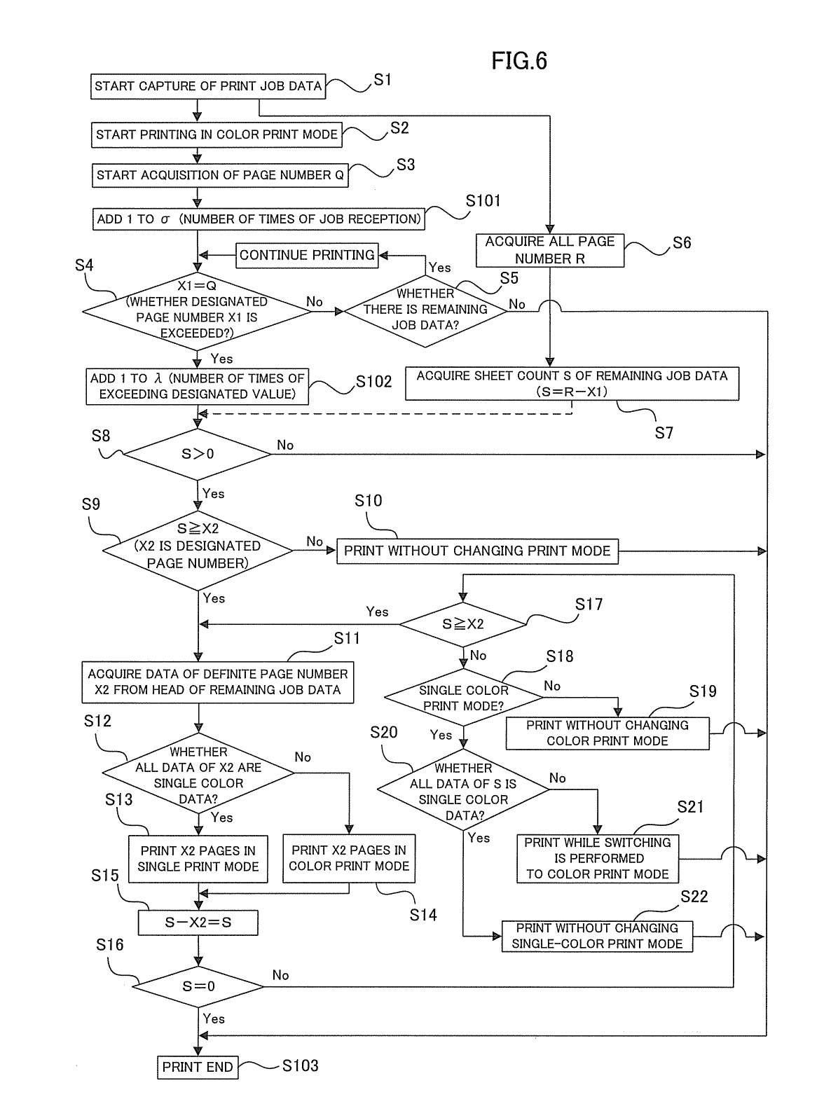

Next, the print operation (switching operation) of the color image forming apparatus 1 of the third embodiment will be described with reference to FIG. 6. Incidentally, since processes other than step S101 and step S102 of FIG. 6 are the same as those of the first embodiment, only step S101, step S102 and their vicinities will be described here.

After the page number Q (the number of sheets) (hereinafter simply referred to as Q) of image data printed from the start of one print job is acquired (step S3), the parameter correction unit 70 adds 1 to the number a of times of reception of a print job (hereinafter simply referred to as a), and causes the sixth page number storage unit 36f to store a after the addition (step S101). Thereafter, the operation switching determination sheet count X1 (hereinafter simply referred to as X1) is compared with Q, and it is determined whether Q and X1 are equal to each other (step S4). Here, in the case where Q and X1 are equal to each other (step S4, Yes), since the number of printed sheets of the image data as the object of the print job is X1 or more, 1 is added to the number λ of print jobs (hereinafter simply referred to as λ) exceeding the operation switching determination sheet count X1, and k after the addition is stored in the sixth page number storage unit 36f (step S102).

Since subsequent processes are the same as those of the first embodiment, their description will be omitted here.

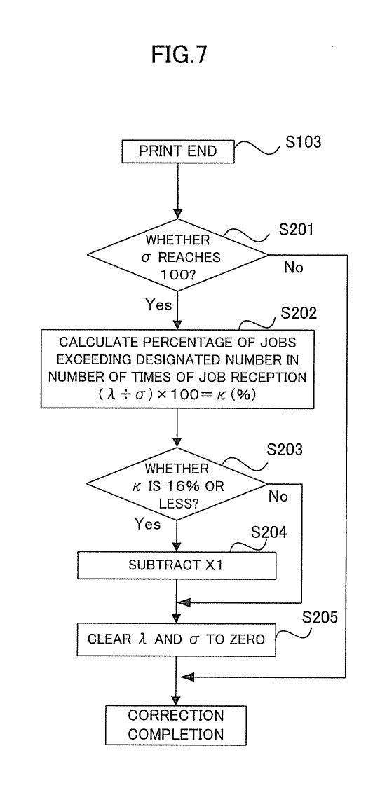

Next, a correction process of X1 will be described on the basis of FIG. 7 to FIG. 9.

First, a process of subtracting X1 will be described with reference to FIG. 7. After the print process is ended (“print end” of FIG. 6, step S103), the parameter correction unit 70 determines whether a reaches a designated value (100 in the third embodiment, however, it may be suitably decided according to the characteristics of the color image forming apparatus 1 or the use state of the user) (step S201). Here, in the case where a does not reach 100 (step S201, No), the parameter correction unit 70 determines that it is unnecessary to change X1, and the correction process is ended.

In the case where σ reaches 100 (step S201, yes), the parameter correction unit 70 calculates, as κ(%) (hereinafter simply referred to as κ), the percentage (ratio) of λ in σ (step S202). The calculation result κ indicates the ratio of the number of print jobs in which a process (hereinafter referred to as an optimizing image formation process) subsequent to step S8 in FIG. 6 is executed to the number of print jobs received in a definite period.

When κ is a small value (the ratio is low) as compared with a target value, the data amount of one print job in the image forming apparatus is relatively small, that is, many of the print jobs are small in the number of sheets.

When return is made to the description of the flowchart of FIG. 7, the parameter correction unit 70 determines whether κ is 16% or less (in the third embodiment, 50% is a target value, and since it is determined whether X1 is corrected or not based on whether κ is within the standard deviation (±34%) with respect to 50%, it is made 16% (50%−34%=16%), however, it may be changed according to the use state of the user) (step S203). In the case where κ is larger than 16% (step S203, No), the parameter correction unit 70 skips the process of step S204. On the other hand, in the case where κ is 16% or less (step S203, Yes), the parameter correction unit 70 subtracts X1 (step S204). Incidentally, although the amount of subtraction is made 2 in this embodiment, the user may arbitrarily decide it.

As stated above, that k is 16% or less means that almost all of the print jobs of the received past print history (σ) (100 times) are print jobs of the data amount which does not reach X1, and indicates that the printing is completed while the optimizing image formation process is not performed. That the print mode is not changed in many of print jobs means that the probability that printing is performed in the color print mode is high and there is a possibility that the wear of the process units 6Y, 6M, 6C and 6K is large. Accordingly, when X1 is subtracted, with respect to a print job received after that, even if the data amount of the print job is small (a small number of sheets), the optimizing image formation process comes to function.

Thereafter, the parameter correction unit 70 clears λ and σ stored in the sixth page number storage unit 36f to zero (step S205).

Here, the reason why λ and σ are cleared to zero will be described. The use mode of the color image forming apparatus 1 is changed every time, and when X1 is changed according to the change, the use mode can be more suitably coped with. When the value of K is calculated from the total number of received print jobs from the time of use start of the color image forming apparatus 1, there is a case where it takes a considerable time till the change of X1 appears. That is, since the value of κ is the result obtained by dividing λ by α, when the value of a becomes large, the change of λ becomes difficult to reflect on the value of κ, and accordingly, as σ becomes large (that is, as the use period of the color image forming apparatus 1 becomes long), it becomes difficult to exert an influence on the value of κ unless the value of λ is considerably changed. The parameter correction unit 70 clears λ and σ to zero so that the past history result does not deviate from the latest history.

Up to here, the process in the case where κ is a small value (the ratio is low) has been described, however, in the case where κ is a large value (the ratio is high) relative to a target value, the data amount of one print job of the color image forming apparatus 1 is relatively large, that is, many of the print jobs are large in the number of sheets. This means that the probability that the optimizing image formation process is performed is high.

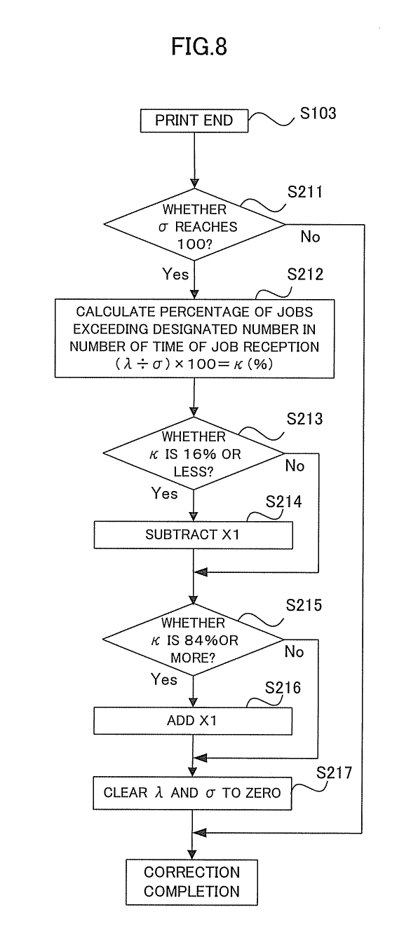

The probability that the optimizing image formation process is performed is high means that the wear of the process units 6Y, 6M, 6C and 6K is suppressed, however, since the operation switching of the process units 6Y, 6M, 6C and 6K is frequently performed, there is a possibility that the productivity of printing is reduced. Thus, the parameter correction unit 70 performs addition, not the foregoing subtraction, on X1, and with respect to a print job received after that, even in the case where data amount is large (a large number of sheets), it is necessary to suppress the number of times of execution of the optimizing image formation process. Hereinafter, a description will be made on the basis of on FIG. 8. Incidentally, since step 211 to step S214 of FIG. 8 are similar to step S201 to step S204 of FIG. 7, their description will be omitted here.

In the case where κ is 84% or more (as stated above, in the case where 50% is made the target value, the standard deviation (34%) is considered, and 50%+34%=84% is obtained, however, it may be changed according to the use mode of the user) (step S215, Yes), the parameter correction unit 70 adds 2 to X1 (the numerical value to be added is arbitrary) (step S216). Thereafter, the parameter correction unit 70 clears λ and σ stored in the sixth page number storage unit 36f to zero (step S217).

On the other hand, in the case where κ is less than 84% (step S215, No), the parameter correction unit 70 skips step 216, and directly clears λ and σ stored in the sixth page number storage unit 36f to zero (step S217).

As stated above, the parameter correction unit 70 performs addition or subtraction on the value of X1 based on the history (λ, σ) of the printing operation, so that the execution of the optimizing image formation process in accordance with the use method (a small amount of print or a large amount of print) of the color image forming apparatus 1 is realized.

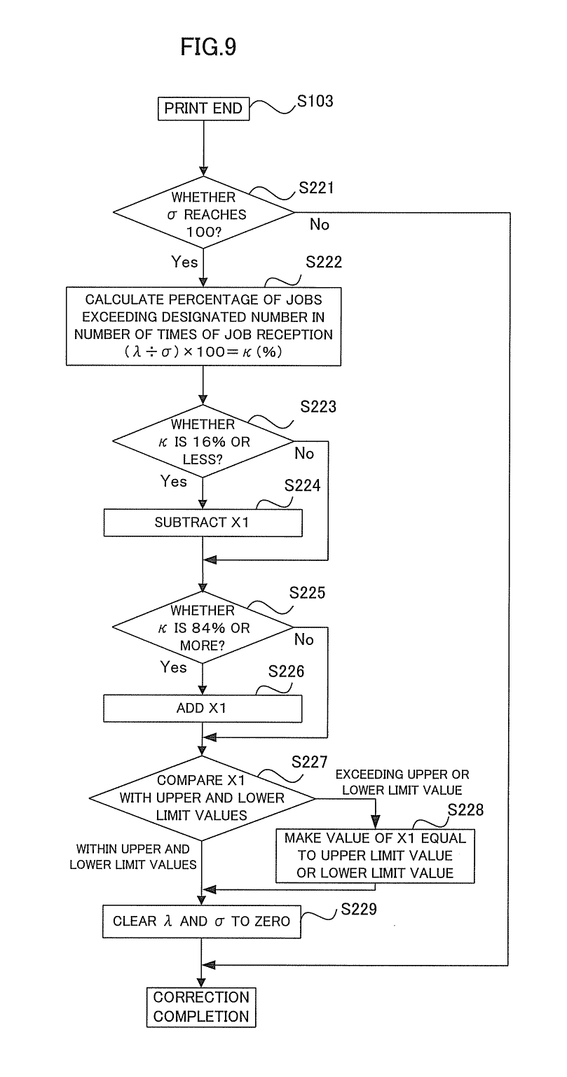

Up to here, although the process of increasing or decreasing the value of X1 has been described, in the case where a print job of a small amount of data continues for a short time or temporarily, or reversely, in the case where a print job of a large amount of data continues for a short time or temporarily, the value of X1 is frequently updated, and the value of X1 becomes minimum or maximum. After such a state is reached, in the case where a print job of average data continues, until the value of X1 again becomes a suitable value, a state continues in which the wear of the process units 6Y, 6M, 6C and 6K proceeds, or the productivity of printing is reduced. In order to avoid these states, the upper and lower limit values (designated range) are previously defined for X1, and when X1 becomes the upper or lower limit value, it is necessary that even if the addition or subtraction is made, the value is not updated. FIG. 9 shows an example of a process in which the upper and lower limit values are provided. Incidentally, since step S221 to step S226 of FIG. 9 are similar to step S211 to step S216 in FIG. 8, their description will be omitted here.

The parameter correction unit 70 compares the value of X1 with the previously defined upper and lower limit values, and determines whether X1 is within the upper and lower limit values (step S227). Here, in the case where X1 is not within the upper and lower limit values (step S227, exceeding the upper or lower limit value), the parameter correction unit 70 makes the value of X1 the same value as the upper limit value (or the lower limit value) (step S228), and clears λ and σ stored in the sixth page number storage unit 36f to zero (step S229).

On the other hand, in the case where X1 is within the upper and lower limit values (step S227, within the upper and lower limit values), the parameter correction unit 70 directly clears λ and σ stored in the sixth page number storage unit 36f to zero (step S229).

From the above, the parameter correction unit 70 prevents X1 from being excessively updated, and X1 is appropriately updated.

In the third embodiment, although the comparison with the value of κ is performed using two numerical values of 16% and 84%, the comparison with one value (for example, 50% of the target value) may be performed.

In the third embodiment, although the numerical value correction is performed for the first operation switching determination sheet count (X1) (designated page number) in the first embodiment, the same correction can be performed for the designated time (T1) (designated time) from the driving start of the photoconductive drum 8K in the second embodiment.

That is, in the flowcharts of FIG. 6 to FIG. 9, the number of times of reception of a print job is made σ (the number of print jobs for which the image formation process is performed), the number of print jobs exceeding T1 time is made λ (the number of print jobs in which the elapsed time from the time when the image formation process is started for the image data reaches the T1 time), and the conversion of parameters and steps similar to the second embodiment is performed in FIG. 6. By doing so, the same correction can be performed also on the T1 time.

Incidentally, the print mode control unit corresponds to the system control unit 24, the ROM 26, the RAM 28, the image data determination unit 34, the image formation page number acquiring means 35, and the page number storage unit 36 in the embodiment.

The image formation process unit corresponds to the printer unit 3 (mainly the image processing unit 32, the image memory unit 30, and the printer main control unit 50) in the embodiment.

Besides, the change unit corresponds to the parameter correction unit 70, and the page number storage unit 36 in the third embodiment.

The present invention is not limited to the above embodiments, but may be variously modified and carried out within the scope not departing from the gist.

Besides, although the invention has been described in detail by using the specific mode, it would be apparent for one of ordinary skill in the art that various modifications and improvements can be made without departing the sprit and the scope of the invention.

As described above in detail, according to the invention, it is possible to provide the image forming apparatus and the image forming method, which can achieve the throughput of a print job adapted to the use state of the user and the wear suppression of the process unit adapted to the use state of the user.

What is claimed is:

1. An image forming apparatus, comprising:
an image formation process unit configured to perform an image formation process on image data in units of print jobs in a print mode of either one of a single-color print mode and a color print mode;
a print mode control unit configured to control the print mode to become the color print mode from the first page of the image data to a page of a designated page number, and to control the print mode to become either one of the single-color print mode and the color print mode in a case where the designated page number is reached; and
a change unit configured to change the designated page number based on the number of the print jobs.

2. The image forming apparatus according to claim 1, wherein the change unit changes the designated page number based on the number of print jobs for which the image formation process unit performs the image formation process.

3. The image forming apparatus according to claim 1, wherein the change unit changes the designated page number based on the number of print jobs in which the page number of the image data reaches the designated page number.

4. The image forming apparatus according to claim 1, wherein the change unit changes the designated page number based on a ratio of the number of print jobs for which the image formation process unit performs the image formation process to the number of print jobs in which the page number of the image data reaches the designated page number.

5. The image forming apparatus according to claim 4, wherein the change unit performs subtraction to change the designated page number in a case where the ratio is smaller than at least a designated threshold, and performs addition to change the designated page number in a case where the ratio is larger than at least the designated threshold.

6. The image forming apparatus according to claim 4, wherein the change unit changes the designated page number, and then zeros the number of print jobs for which the image formation process unit performs the image formation process and the number of print jobs in which the page number of the image data reaches the designated page number.

7. The image forming apparatus according to claim 1, wherein in a case where the designated page number is not within a designated range, and in a case where it is larger than an upper limit value of the designated range, the change unit changes the designated page number to become a value equal to the upper limit value, and in a case where it is smaller than a lower limit value of the designated range, the change unit changes the designated page number to become a value equal to the lower limit value.

8. An image forming apparatus, comprising:
an image formation process unit configured to perform an image formation process on image data in units of print jobs in a print mode of either one of a single-color print mode and a color print mode;
a print mode control unit configured to control the print mode to become the color print mode until a designated time has passed since an image formation start of the image data formation process unit on the image data, and to control the print mode to become either one of the single-color print mode and the color print mode in a case where the designated time has passed; and
a change unit configured to change the designated time based on the number of the print jobs.

9. The image forming apparatus according to claim 8, wherein the change unit changes the designated time based on the number of print jobs for which the image formation process unit performs the image formation process.

10. The image forming apparatus according to claim 8, wherein the change unit changes the designated time based on the number of print jobs in which an elapsed time from the time when the image formation process unit starts the image formation process on the image data reaches the designated time.

11. The image forming apparatus according to claim 8, wherein the change unit changes the designated time based on a ratio of the number of print jobs for which the image formation process unit performs the image formation process to the number of print jobs in which the elapsed time from the time when the image formation process unit starts the image formation process on the image data reaches the designated time.

12. The image forming apparatus according to claim 11, wherein the change unit performs subtraction to change the designated time in a case where the ratio is smaller than at least a designated threshold, and performs addition to change the designated time in a case where the ratio is larger than at least the designated threshold.

13. The image forming apparatus according to claim 11, wherein the change unit changes the designated time, and then zeros the number of print jobs for which the image formation process unit performs the image formation process and the number of print jobs in which the elapsed time from the time when the image formation process unit starts the image formation process on the image data reaches the designated time.

14. The image forming apparatus according to claim 8, wherein in a case where the designated time is not within a designated range, and in a case where it is larger than an upper limit value of the designated range, the change unit changes the designated time to become a value equal to the upper limit value, and in a case where it is smaller than a lower limit value of the designated range, the change unit changes the designated time to become a value equal to the lower limit value.

15. An image forming method, comprising:
performing an image formation process on image data in units of print jobs in a print mode of either one of a single-color print mode and a color print mode;
controlling the print mode to become the color print mode from the first page of the image data to a page of a designated page number, controlling the print mode to become either one of the single-color print mode and the color print mode in a case where the designated page number is reached; and
changing the designated page number based on the number of the print jobs in a case where the image formation process reaches a designated number of times.

16. The image forming method according to claim 15, wherein when the designated page number is changed, the designated page number is changed based on the number of print jobs for which the image formation process is performed.

17. The image forming method according to claim 15, wherein when the designated page number is changed, the designated page number is changed based on the number of print jobs in which the page number of the image data reaches the designated page number.

18. The image forming method according to claim 15, wherein when the designated page number is changed, the designated page number is changed based on a ratio of the number of print jobs for which the image formation process is performed to the number of print jobs in which the page number of the image data reaches the designated page number.

19. The image forming method according to claim 18, wherein when the designated page number is changed, subtraction is performed to change the designated page number in a case where the ratio is smaller than at least a designated threshold, and addition is performed to change the designated page number in a case where the ratio is larger than at least the designated threshold.

20. The image forming method according to claim 18, wherein after the designated page number is changed, the number of print jobs for which the image formation process is performed and the number of print jobs in which the page number of the image data reaches the designated page number are made zero.
